(19) United States
(12) Patent Application Publication
(10) Pub. No.: US 2008/0174126 A1
(43) Pub. Date: Jul. 24, 2008

(54) LATCH DEVICE FOR MOUNTING SHEET-LIKE LININGS

(76) Inventor: Samruol Kong, Lynnwood, WA (US)

Correspondence Address: OSTRAGER CHONG FLAHERTY & BROITMAN, P.C., 570 LEXINGTON AVENUE, FLOOR 17, NEW YORK, NY, 10022-6894, US

(21) Appl. No.: 11/624,727

(22) Filed: Jan. 19, 2007

(51) Int. Cl. E05C 1/08; B64C 1/14

(52) U.S. Cl. 292/163; 244/129.1

(57) ABSTRACT

A latch device is provided for attaching interior linings, panels, or other surface components to an interior structure or part, such as the passenger compartment of an aircraft, without using any tool. The latch device has a latch base, a support member having a latch groove positioned rearwardly of a forwardly projecting tongue, a latch pawl above the latch groove movable under spring pressure between a pawl-detent position and a pawl-release position, and an actuator member having a striker pin retained between spaced-apart arms and an actuator end part at its opposite end. An edge portion of an interior lining is aligned with the striker pin and fed onto the tongue and into the latch groove against the spring pressure on the latch pawl, and can readily be removed by levering the actuator end part to unlatch the pawl from the striker pin.

### TECHNICAL FIELD

The present invention relates generally to a latch device for mounting linings, panels, or other surface components in interior environments. More particularly, the present invention is related to a latch device for easily mounting a lining to an interior structure or part without using any tool.

### BACKGROUND OF THE INVENTION

Interior linings, panels, and other surface components need to be mounted in interior environments with fastener devices that allow them to be easily installed, removed for cleaning, or replaced. The fastener devices are intended to hold the interior linings, etc., firmly in place during operating conditions. However, interior linings in the passenger cabins of commercial airplanes, for example, are installed with conventional fastening methods that are generally cumbersome and time-consuming. The installation and removal time greatly affect the cost of setting up and maintaining the passenger compartments in commercial transport. This installation problem exists in numerous other instances in any industry. To reduce the cost of servicing interior environments, it is desirable to have fastener devices or mountings for interior linings that have simple and inexpensive parts that allow linings to be easily and quickly installed and removed.

### SUMMARY OF THE INVENTION

The present invention is therefore directed to a latch device for attaching a planar, flexible sheet-like object, such as a lining, panel, or other surface component, to an interior structure or part without using any tool.

In accordance with the invention, a latch device, for installing a planar, flexible sheet-like object to an interior structure or part, comprises: a latch base for attachment to the interior structure or part; a latch support member extending from the latch base and having a latch groove positioned rearwardly of a forwardly projecting tongue having a generally flat or planar upper surface thereon; a latch pawl positioned above said latch groove and adapted to be movable under spring pressure applied by a spring-biasing member between a pawl-detent position proximate said latch groove and a pawl-release position displaced a given spacing from said latch groove; and a latch actuator member having a striker pin retained between a pair of spaced-apart arms at one end and an actuator end part extending in an opposite direction at an opposite end therefrom.

For use of the latch device, is configured for use in which an edge portion of the sheet-like object is fed with the striker pin of the latch actuator member aligned therewith onto the planar upper surface of the tongue of the latch support member and pushed into the latch groove and into resilient contact with the latch pawl to displace the latch pawl against the spring pressure of the spring-biasing member to the pawl-release position, so that the edge portion and striker pin can become seated in the latch groove and retained therein by the latch pawl returning to the pawl-detent position under the spring pressure of the spring-biasing member.

The sheet-like object can be readily removed by levering the actuator end part on the sheet-like object so that the striker pin at the opposite end pushes the latch pawl away from the latch groove to the pawl-release position, and the striker pin and edge portion can then be removed from the latch groove. A lining, panel, or other surface component can thus be securely attached along one edge to the interior structure or part by using a pair of latch assemblies spaced apart on opposite sides of the edge portion, and inserting the edge portion with a corresponding pair of latch actuator members until their striker pins latch under the latch pawls into the grooves, and removed by pushing on the actuator end parts to unlatch the striker pins, all without requiring any tool.

The present invention as a whole, together with its further objects and attendant advantages, will be best understood by reference to the following detailed description, taken in conjunction with the accompanying drawing.

### BRIEF DESCRIPTION OF THE DRAWINGS

FIG. 1 shows a latch device of the present invention in the latch position.

FIG. 2 shows the latch device of FIG. 1 in the unlatched position.

FIG. 3 shows the latch device with the latch actuator member in the uninstalled position before it is inserted with the edge of a lining into the groove of the latch device.

### DETAILED DESCRIPTION OF THE INVENTION

In the following description, the same reference numerals are used to refer to the same components shown in the Figures.

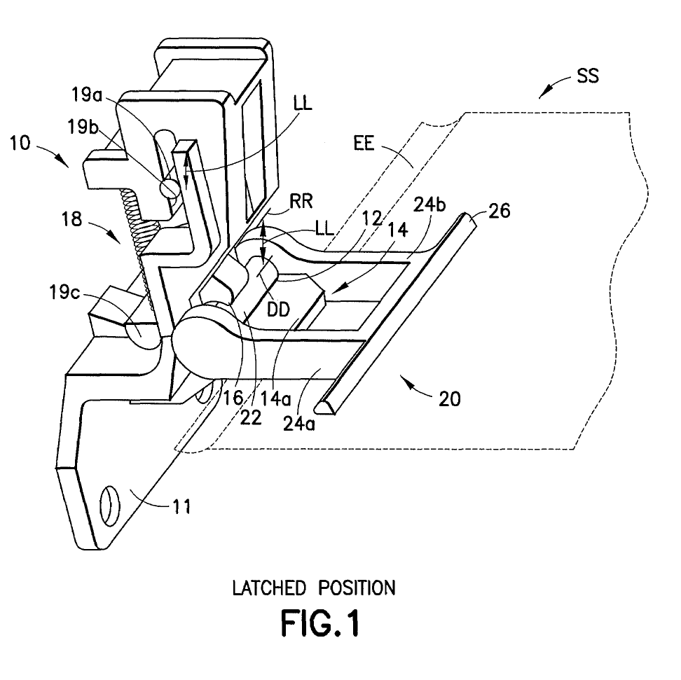

Referring now to FIG. 1, a preferred embodiment of a latch device 10 in the present invention is shown having a latch base 11 for attachment to an interior structure or part to which a lining, panel or other surface component is to be mounted, and a latch support member 20 extending from the latch base 10 and having a latch groove 12 positioned rearwardly of a forwardly projecting tongue 14. The tongue 14 has a generally flat or planar upper surface 14a for supporting the feeding in of an edge portion EE of a generally planar, flexible sheet-like object SS, such as a lining, panel, or other surface component (indicated in dashed lines). A movable latch pawl 16 is positioned above the latch groove 12 and adapted to be movable under spring pressure applied by a spring-biasing member 18 between a pawl-detent position DD proximate said latch groove and a pawl-release position RR displaced a given spacing LL from the latch groove to allow a striker pin to be inserted therein (described below).

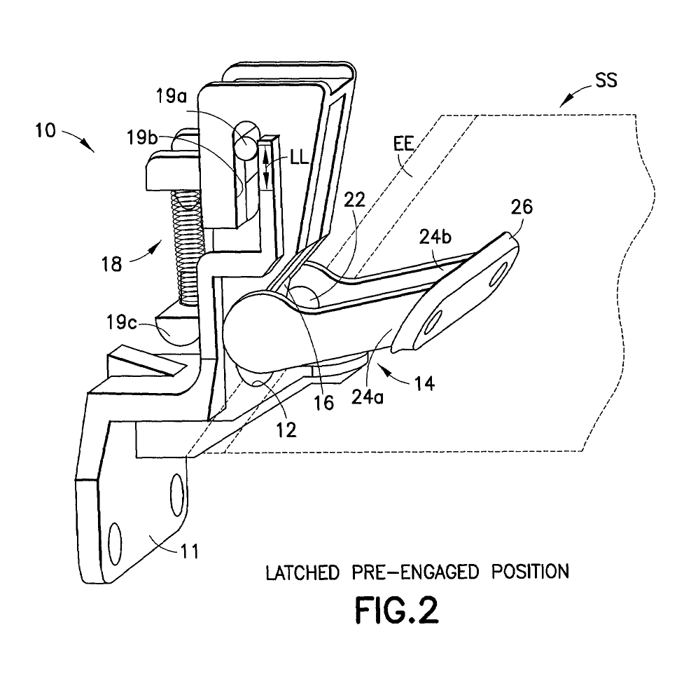

Referring to FIG. 2, which shows the latch device in the pre-engaged position, the latch actuator member 20 has a striker pin 22 retained between a pair of spaced-apart arms 24a, 24b at one end and an actuator end part 26 extending in an opposite direction at an opposite end thereof. The movable latch pawl 16, and the pawl follower member 19a sliding in the guide slot 19b along with the spring retainer 19c, are displaced a distance LL upward (to the pawl-release position RR in FIG. 1) when the edge portion EE and the striker pin 22 are fed into the latch groove 12. This allows the edge portion EE and striker pin to be moved fully rearwardly into the groove 12, until the pawl returns along the downwardly sloped back side of the striker pin and clicks back into the pawl-retainer position (DD in FIG. 1).

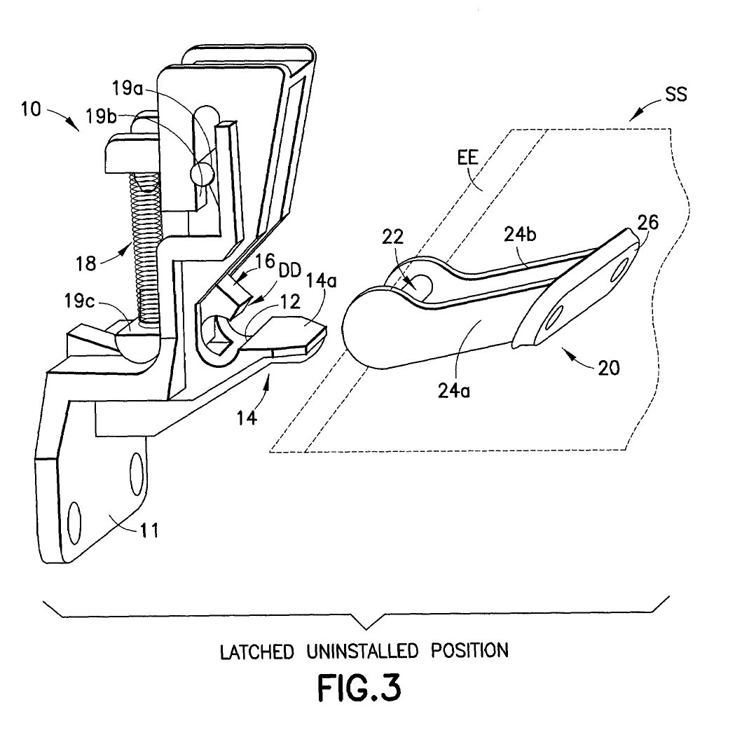

FIG. 3 shows the latch device with the sheet-like object SS and the latch actuator member 20 in the uninstalled position. The edge portion EE and the striker pin 22 are aligned with in parallel to be fed onto the upper surface 14a of the tongue 14 and into the latch groove 12. The latch pawl 16 in its resting, pawl-detent position DD blocks full access of the edge portion EE and striker pin 22 into the latch groove 12. The striker pin 22 will therefore push the latch pawl 16 upward against the spring pressure of the spring-biasing member 18 to displace it to the pawl-release position so that the edge portion EE and striker pin 22 can become fully seated in the latch groove 12.

The components of the latch device and their characteristics may be designed or selected depending upon the type of material being installed and the characteristics of the interior structure. If the lining material is relatively soft and light, the spring force of the spring-biasing member and the pawl mechanism may be made relatively light, whereas if the lining material is relatively stiff or of heavier weight, the spring force may be made larger. The latch base may be made in any suitable configuration and employ any suitable fastener method depending upon the interior structure.

This latch device of the present invention provides particularly advantageous solutions for use in the passenger compartment of commercial aircraft. It provides a means of quick attachment, so that the lining materials in the airplane interior can be quickly removed and re-installed for cleaning or replacement. By positioning the latch devices correctly, the interior linings can be securely maintained in their installed position without any adverse movement in normal flight condition. Installation and removal can be effected by the ground crew without any tools required to remove or install the linings from or into their support brackets. Thus, cabin servicing and maintenance times can be significantly reduced for advantageous cost savings.

While the invention has been described in connection with one or more preferred embodiments, it is to be understood that the specific systems, components, and methods which have been described are merely illustrative of the principles of the invention, and numerous modifications may be made to the methods and apparatus described without departing from the spirit and scope of the invention as defined by the appended claims.

1. A latch device, for installing a planar, flexible sheet-like object to an interior structure or part, comprising:
a latch base for attachment to the interior structure or part;
a latch support member extending from the latch base and having a latch groove positioned rearwardly of a forwardly projecting tongue having a generally flat or planar upper surface thereon;
a latch pawl positioned above said latch groove and adapted to be movable under spring pressure applied by a spring-biasing member between a pawl-detent position proximate said latch groove and a pawl-release position displaced a given spacing from said latch groove; and
a latch actuator member having a striker pin retained between a pair of spaced-apart arms at one end and an actuator end part extending in an opposite direction at an opposite end therefrom.

2. A latch device according to claim 1 configured for use in which an edge portion of the sheet-like object is fed with the striker pin of the latch actuator member aligned therewith onto the planar upper surface of the tongue of the latch support member and pushed into the latch groove and into resilient contact with the latch pawl to displace the latch pawl against the spring pressure of the spring-biasing member to the pawl-release position, so that the edge portion and striker pin can become seated in the latch groove and retained therein by the latch pawl returning to the pawl-detent position under the spring pressure of the spring-biasing member.

3. A latch device according to claim 1 configured for use in which the sheet-like object is removed by levering the actuator end part on the sheet-like object so that the striker pin at the opposite end pushes the latch pawl away from the latch groove to the pawl-release position, and the striker pin and edge portion can then be removed from the latch groove.

4. A latch device according to claim 1, wherein the sheet-like material is a lining, panel, or other surface component to be installed in an interior environment.

5. A latch device according to claim 4, wherein the interior environment is a passenger compartment of an aircraft.

6. A latch device according to claim 1 configured for use in which a pair of latch assemblies is provided spaced apart on opposite sides of the edge portion, and the edge portion with a corresponding pair of latch actuator members are inserted with their striker pins into the latch grooves of the latch assemblies.

7. A latch device according to claim 1 configured for use in which the sheet-like object is installable and removable from the latch device without the use of any tool.
